(19) United States
(12) Patent Application Publication
(10) Pub. No.: US 2025/0261072 A1
(43) Pub. Date: Aug. 14, 2025

(54) METHOD AND ELECTRONIC DEVICE FOR SLICE ALLOCATION IN A TELECOMMUNICATION NETWORK

(71) Applicant: SAMSUNG ELECTRONICS CO., LTD., Suwon-si (KR)

(72) Inventors: Chandan Swarup Patra, Bangalore (IN); Imran Mohammed, Bangalore (IN); Sridharan Natarajan, Bangalore (IN); Sri Charan Birudaraju, Bangalore (IN); Sulabh Jain, Bangalore (IN)

(73) Assignee: SAMSUNG ELECTRONICS CO., LTD., Suwon-si (KR)

(21) Appl. No.: 19/013,787

(22) Filed: Jan. 8, 2025

Related U.S. Application Data
(63) Continuation of application No. PCT/KR2024/017999, filed on Nov. 14, 2024.

(30) Foreign Application Priority Data
Feb. 14, 2024 (IN) 202441010255

(51) Int. Cl. H04W 36/26; H04W 36/00; H04W 36/14

(52) U.S. Cl. CPC H04W 36/26; H04W 36/00833; H04W 36/14

(57) ABSTRACT

A method for dynamic network slice allocation by an electronic device for a data analytics system in a telecommunication network, includes: monitoring one or more application usage patterns of one or more user equipments (UEs) which is connected to a default network slice in the telecommunication network; classifying the one or more UEs into one or more categories based on the one or more application usage patterns; and allocating one or more network slices having predefined qualities of service (QoS) to the one or more UEs based on the one or more categories.

### CROSS-REFERENCE TO RELATED APPLICATIONS

This application is a by-pass continuation application of International Application No. PCT/KR2024/017999, filed on Nov. 14, 2024, which is based on and claims priority to Indian Patent Application No. 202441010255, filed on Feb. 14, 2024, the disclosures of which are incorporated by reference herein in their entireties.

### BACKGROUND

### 1. Field

The disclosure relates to the field of telecommunication networks, and in particular, to a method and system for dynamic slice allocation in a telecommunication network.

### 2. Description of Related Art

A network slice in 5^{th} Generation telecommunication network is a logical block used for targeting different services with different requirements on speed, latency, and reliability. Various types of smart devices or User Equipment (UE) which communicate using the telecommunication network are allocated with a default network slice each. In 5G solutions, slicing may be based on a Single Network Slice Selection Assistance Information (S-NSSAI) which may constitute of Slice/Service Type (SST) and Slice Differentiator (SD) values provisioned in the UE. A default slice may be allocated for the lifetime of the UE. The network slices may be allocated by default and may remain the same for lifetime. Conventional systems may not provide a mechanism to change the default network slice. Such default network slice may be pre-allocated without considering application usage pattern of the UE. As the default slice allocated to the user may only provide a specific Quality of Service (QoS), it may not fulfill the network requirements of the UE for each application. This may impact the user experience and may degrade the QoS for the user equipment. By enabling only a default network slice for each UE, available network resources and their capabilities that may increase QoS may be under-utilized Therefore, there is a need for a solution capable of allocating the network slice to the UE based on usage pattern of the UE.

The information in this background section is only for understanding and should not be taken as prior art already known to a person skilled in the art.

### SUMMARY

According to an aspect of the disclosure, a method for network slice allocation in a telecommunication network, is provided. The method may comprise: monitoring one or more application usage patterns of one or more user equipment (UEs) which are connected to a default network slice in the telecommunication network; classifying the one or more UEs into one or more categories based on the one or more application usage patterns; and allocating, by the data analytics system, one or more network slices having predefined qualities of service (QoS) to the one or more UEs based on the one or more categories.

The one or more application usage patterns may be monitored based on UE communication service data received from a first network function of the telecommunication network.

A first network slice allocated to one or more first UEs classified according to a first category may be different from other network slices allocated to other UEs classified according to other categories.

The method may further include: monitoring a mean opinion score (MOS) value indicating a service experience of one or more applications being used by the one or more first UEs based on allocating the first network slice; and replacing the first network slice with a second network slice based on the MOS value being below a predefined threshold value.

The method may further include redirecting connection of the one or more first UEs from the default network slice to the first network slice without changing a single network slice selection assistance information (S-NSSAI) value in the one or more first UEs, wherein the S-NSSAI value indicates the default network slice.

The method may further include transmitting first information indicating the first network slice to the one or more first UEs, wherein the first information is for replacing second information indicating the default network slice in the one or more first UEs. The first information may indicate a change of the default network slice of the one or more first UEs to the first network slice.

The method may further include: determining a movement pattern of the one or more first UEs based on one or more previous handovers in the telecommunication network of the one or more first UEs, wherein the one or more previous handovers are determined based on UE communication service data received from a first network function of the telecommunication network; and pre-defining a second network slice to be allocated to the one or more first UEs based on the movement pattern and a stored list of one or more second network slices allocated to the one or more first UEs in the one or more previous handovers.

According to an aspect of the disclosure, a method of dynamic network slice allocation in a telecommunication network, includes: monitoring, by a data analytics system associated with the telecommunication network, one or more application usage patterns of one or more User Equipment (UEs) based on the one or more UEs is connected to a default network slice in the telecommunication network; classifying, by the data analytics system, the one or more UEs into one or more categories based on the one or more application usage patterns; allocating, by the data analytics system, one or more network slices having predefined Qualities of Service (QoS) to the one or more UEs, wherein a first network slice allocated to one or more first UEs classified according to a first category is different from other network slices allocated to other UEs in other categories; and transmitting, by the data analytics system, first information indicating the first network slice to the one or more first UEs, wherein the first information is for replacing second information indicating the default network slice in the one or more first UEs, wherein the first information indicates a change of the default network slice of the one or more first UEs to the first network slice.

The one or more application usage patterns may be monitored based on UE communication service data received from a first network function of the telecommunication network.

The method may further include: monitoring, by the data analytics system, a Mean Opinion Score (MOS) value indicating a service experience of one or more applications being used by the one or more first UEs based on allocating the first network slice; and replacing, by the data analytics system, the first network slice with a second network slice based on the MOS being below a predefined threshold value.

According to an aspect of the disclosure, a method performed at User Equipment (UE) for dynamic network slice allocation in a telecommunication network, includes: receiving, by the UE, first information indicating a first network slice allocated to the UE from a data analytics system associated with the telecommunication network; replacing, by the UE, second information indicating a default network slice in the UE with the first information; and establishing, by the UE, a connection with the first network slice based on replacing the second information with the first information.

The establishing the connection with the first network slice may include transmitting, by the UE, a registration request to a second network element that facilitates allocation of the first network slice.

According to an aspect of the disclosure, an electronic device for a data analytics system for network slice allocation in a telecommunication network, may comprise: one or more processors; and memory storing instructions, which, when executed by the one or more processors, cause the electronic device to: monitor one or more application usage patterns of one or more user equipment (UEs) which areconnected to a default network slice in the telecommunication network; classify the one or more UEs into one or more categories based on the one or more application usage patterns; and allocate one or more network slices having predefined qualities of service (QoS) to the one or more UEs based on the one or more categories.

According to an aspect of the disclosure, a data analytics system for dynamic network slice allocation in a telecommunication network, includes: one or more processors; and a memory, storing instructions, which, when executed by the one or more processors, cause the data analytics system to: monitor one or more application usage patterns of one or more User Equipment (UEs) based on the one or more UEs being connected to a default network slice in the telecommunication network; classify the one or more UEs into one or more categories based on the one or more application usage patterns; allocate one or more network slices having predefined Qualities of Service (QoS) to the one or more UEs, wherein a first network slice allocated to one or more first UEs classified according to a first category is different from other network slices allocated to other UEs classified according to other categories; and transmit first information indicating the first network slice to the one or more first UEs, wherein the first information is for replacing second information indicating the default network slice in the one or more first UEs, wherein the first information indicates a change of the default network slice of the one or more first UEs to the first network slice.

The one or more application usage patterns may be monitored based on UE communication service data received from a first network function of the telecommunication network.

The one or more processors may be further configured to execute the instructions to cause the data analytics system to: monitor a Mean Opinion Score (MOS) value indicating a service experience of one or more applications being used by the one or more first UEs based on allocating the first network slice; and replace the first network slice with a second network slice based on the MOS value obeing below a predefined threshold value.

According to an aspect of the disclosure, a User Equipment (UE) for dynamic network slice allocation in a telecommunication network, includes: one or more processors; and a memory, storing instructions, which, when executed by the one or more processors, causes the UE to: receive first information indicating a first network slice allocated to the UE from a data analytics system associated with the telecommunication network; replace second information indicating a default network slice in the UE with the first information; and establish a connection with the first network slice based on replacing the second information with the first information.

According to an aspect of the disclosure, a non-transitory computer readable storage medium storing instructions which, when executed by one or more processors of an electronic device, cause the electronic device to perform operations is provided. The operations may comprise monitoring one or more application usage patterns of one or more user equipment (UEs) which are connected to a default network slice in the telecommunication network; classifying the one or more UEs into one or more categories based on the one or more application usage patterns; and allocating, by the data analytics system, one or more network slices having predefined qualities of service (QoS) to the one or more UEs based on the one or more categories.

To establish the connection with the first network slice, the one or more processors may be configured to execute the instructions to cause the UE to transmit a registration request to a second network element that facilitates allocation of the first network slice.

### BRIEF DESCRIPTION OF THE DRAWINGS

The accompanying drawings illustrate exemplary embodiments and, together with the description, explain one or more embodiments. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and regarding the accompanying figures, in which:

FIG. 1A and 1B show an exemplary architecture for dynamic network slice allocation in a telecommunication network using a data analytics system, in accordance with one or more embodiments;

FIG. 1C shows an exemplary architecture of Network Slice Selection Function (NSSF), in accordance with one or more embodiments;

FIG. 1D shows an exemplary architecture for Unified Data Management (UDM), in accordance with one or more embodiments;

FIG. 1E shows an exemplary clustering of one or more User Equipment (UE), in accordance with one or more embodiments;

FIG. 2A and FIG. 2B show detailed block diagrams of a data analytics system, in accordance with one or more embodiments;

FIG. 3 shows a detailed block diagram of a User Equipment (UE), in accordance with one or more embodiments;

FIG. 4A shows a flowchart illustrating an exemplary method of dynamic network slice allocation in a telecommunication network, in accordance with one or more embodiments;

FIG. 4B shows an exemplary call flow diagram for dynamic network slice allocation in a telecommunication network, in accordance with one or more embodiments;

FIG. 4C shows an exemplary call flow diagram for dynamic network slice allocation in a telecommunication network during handover of a User Equipment (UE), in accordance with one or more embodiments;

FIG. 5A shows a flowchart illustrating an exemplary method of dynamic network slice allocation in a telecommunication network involving a User Equipment (UE), in accordance with one or more embodiments;

FIG. 5B shows a flowchart illustrating an exemplary method performed at User Equipment (UE) for dynamic network slice allocation in a telecommunication network, in accordance with one or more embodiments;

FIG. 5C shows an exemplary sequence diagram for dynamic network slice allocation in a telecommunication network involving a User Equipment (UE), in accordance with one or more embodiments, in accordance with one or more embodiments; and

FIG. 6 illustrates a block diagram of an exemplary computer system for implementing one or more embodiments.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether such computer or processor is explicitly shown.

### DETAILED DESCRIPTION

The embodiments described in the disclosure, and the configurations shown in the drawings, are only examples of embodiments, and various modifications may be made without departing from the scope and spirit of the disclosure.

In the present document, the word “exemplary” is used herein to mean “serving as an example, instance, or illustration.” Any embodiment or implementation of the present subject matter described herein as “exemplary” is not to be construed as preferred or advantageous over other embodiments.

While one or more embodiments may have modified forms, description thereof is provided by way of example in the drawings and in detail below. It should be understood, however that such descriptions are not intended to limit the disclosure to a specific form, but on the contrary, the disclosure includes all modifications, equivalents, and alternatives falling within the spirit of the disclosure.

The terms “comprises”, “comprising”, “includes”, or any other variations thereof, are intended to cover a non-exclusive inclusion, such that a setup, device, or method that comprises a list of components, steps, or operations does not include only those components or steps but may include other components, steps, or operations. One or more elements in a system or apparatus proceeded by “comprises . . . a” does not, without more constrain, preclude the existence of other elements or additional elements in the system or method.

Provided are one or more embodiments capable of facilitating dynamic allocation. One or more embodiments may be referred as a network only method as the method of dynamically allocating the network slice based on application usage pattern of the UE may not make changes at the UE end. The changes to adapt to the dynamically allocated network slice may be performed at the network end. One or more embodiments may dynamically allocate the network slice based on application usage pattern of the UE may include interference of the UE along with the actions taken at the network end. In one or more embodiments, a data analytics system monitors an application usage pattern of one or more UEs. The data analytics system may be configured in Network Slice Selection Function (NSSF) of the telecommunication network. A default network slice may be allocated to the UE based on the UE being powered ON. To monitor the UE application usage pattern, the data analytics system may monitor communication service data of each of the one or more UEs available at a first network function of the telecommunication network. As an example, the first network function may be, without limitation, a Network Data Analytics Function (NWDAF) in 5G network. The application usage pattern may facilitate understanding of the usage pattern of user of the UE which indicates the current application used in the UE, uplink traffic of the UE, downlink traffic of the UE and like. Using the application usage pattern, the data analytics system may classify each of the one or more UEs into a plurality of categories based on the application usage pattern of each of the one or more UEs. As an example, the plurality of categories may include, without limitation, audio streaming users, video streaming users, message application using users, browsing application using users and gaming users. Upon classifying each of the one or more UEs, the data analytics system may allocate a network slice having a predefined QoS (Quality of Service) to each of the one or more UEs categorized in each of the plurality of categories, wherein the network slice allocated to each of the one or more UEs in one category is different from the network slice allocated to each of the one or more UEs in other categories of the plurality of categories. The data analytics system may be further configured to redirect connection of the one or more UEs from the default network slice to the allocated network slice without changing a Single Network Slice Selection Assistance Information (S-NSSAI) value indicative of the default network slice in the one or more UEs. Further, the data analytics system may monitor a Mean Opinion Score (MOS) value of the one or more UEs indicative of service experience of one or more applications being used in each of the one or more UEs. If the MOS value is below a predefined threshold value, the data analytics may update the network slice allocated to the UE. In the second method which involves combination of the network and the UE for dynamic slice allocation, the data analytics system transmits information related to the corresponding allocated network slice to the corresponding one or more UEs for replacing information related to a default network slice in the one or more UEs with the information related to the corresponding allocated network slice, indicative of a change of the default network slice of the one or more UEs to the corresponding allocated network slice. In this scenario, S-NSSAI value in the UE is updated. The connection of the UE is interrupted and the UE establishes connection using allocated network slice. Also, the UE is configured to receive the information related to the network slice indicative of the network slice allocated to the UE from the data analytics system and replace the information related to the default network slice in the UE with the information related to the allocated network slice in the UE. Finally, the UE establishes a connection with the allocated network slice upon replacing the information related to the default network slice in the UE.

One or more embodiments may dynamically allocate a network slice based on the application usage pattern of the UE. This may enhance the user experience and may provide increased QoS to the UE as the allocated slice fulfills the network requirements of the UE. One or more embodiments may be performed at a network end, this helps in updating the network slice of the UE without interrupting the connection of the UE with the network. One or more embodiments may classify each of the one or more UEs into a plurality of categories based on the application usage pattern. Each category have different QoS. This helps in classifying the user in the correct category which fulfills the network requirement. One or more embodiments may monitor the user experience upon allocating the network slice and updates the network slice if there is a change in user experience. This helps in dynamically updating the network slice which enhances the user experience and the QoS. One or more embodiment may determine a movement pattern of the UE based on one or more previous handovers of the UE. Using the movement pattern, the network slice to be allocated is pre-defined for the UE during handover of the UE. As the movement pattern of the UE is determined, the network slice to be allocated is predefined in the new location of the UE which helps in dynamically allocating the network slice without monitoring the application usage pattern again in the new location of the UE. The new location here refers to different location from the present location of the UE. This in turn eliminates additional processing for monitoring the application usage pattern and reduces time taken to dynamically allocating a network slice to the UE.

In the following detailed description of one or more embodiments, reference is made to the accompanying drawings that form a part hereof, and in which are shown by way of illustration. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

For convenience of explanation, terms and names defined in the 3rd Generation Partnership Project Radio Access Network (3GPP RAN) standards are used herein. The terms ‘Control plane’, ‘User plane’, ‘Core Network’, Access and Mobility Function (AMF), Network Slice Selection Function (NSSF), Subscriber Data Management (SDM) function, a Network Data Analytics Function (NWDAF), Operations Administration and Maintenance (OAM), Data Network Name (DNN) and Policy Control Function (PCF) are to be interpreted as including such entities from the 3GPP RAN standards.

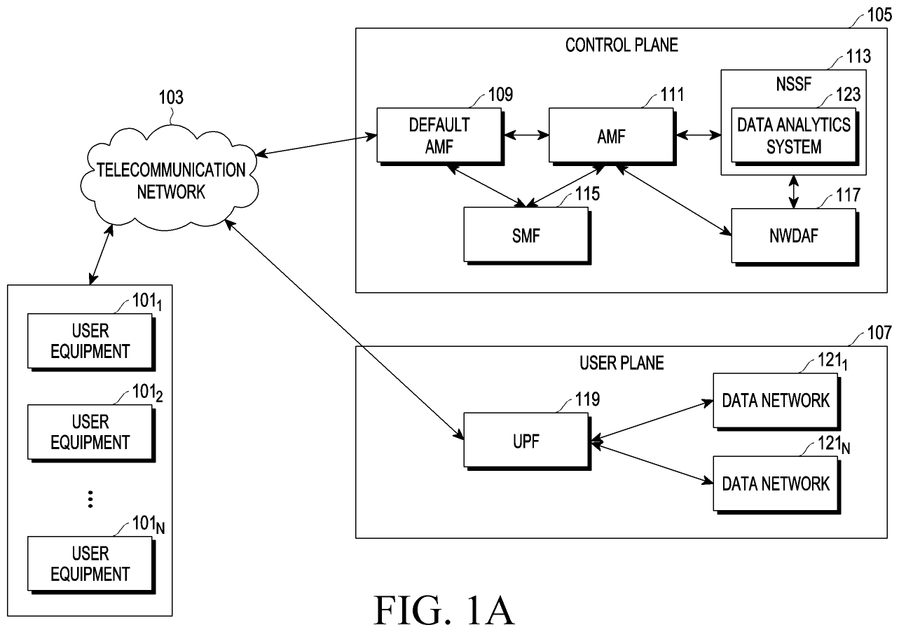

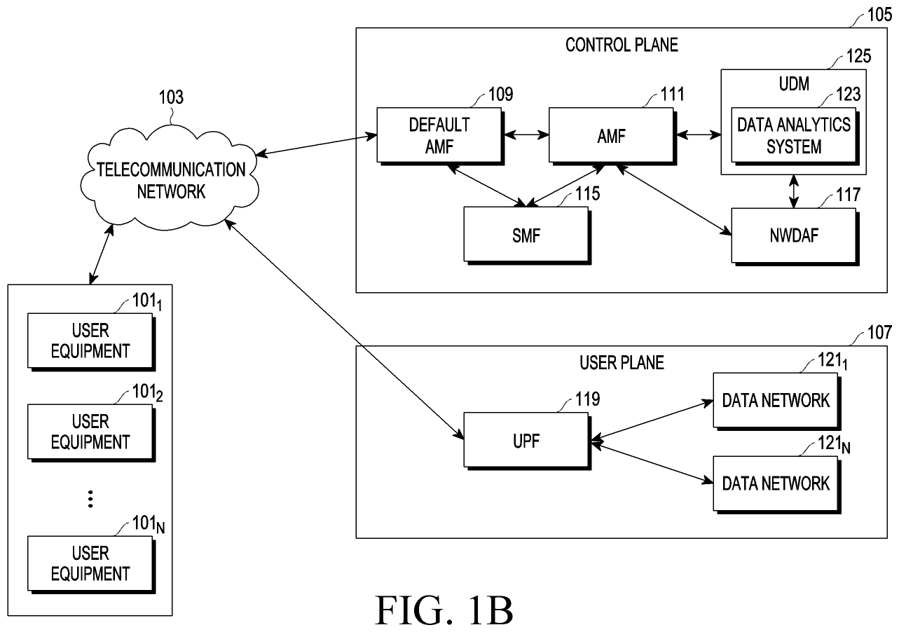

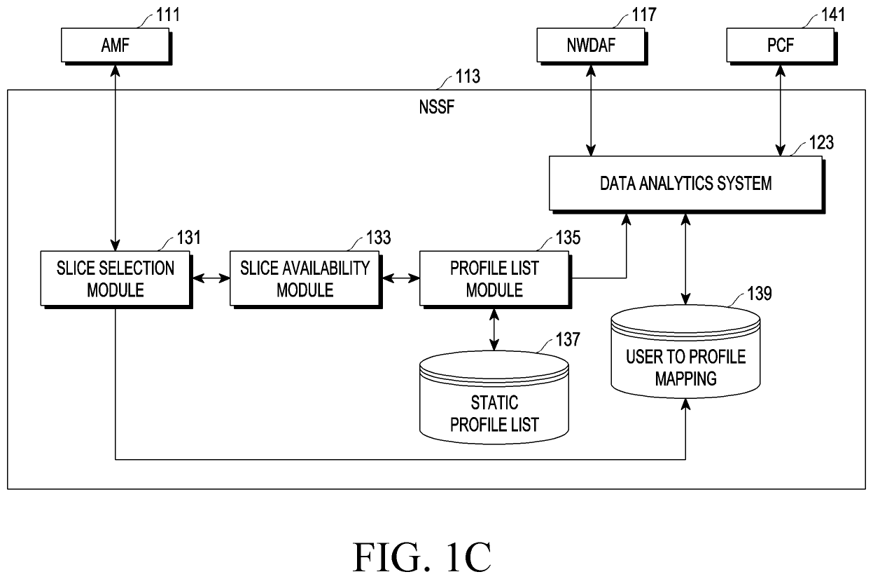

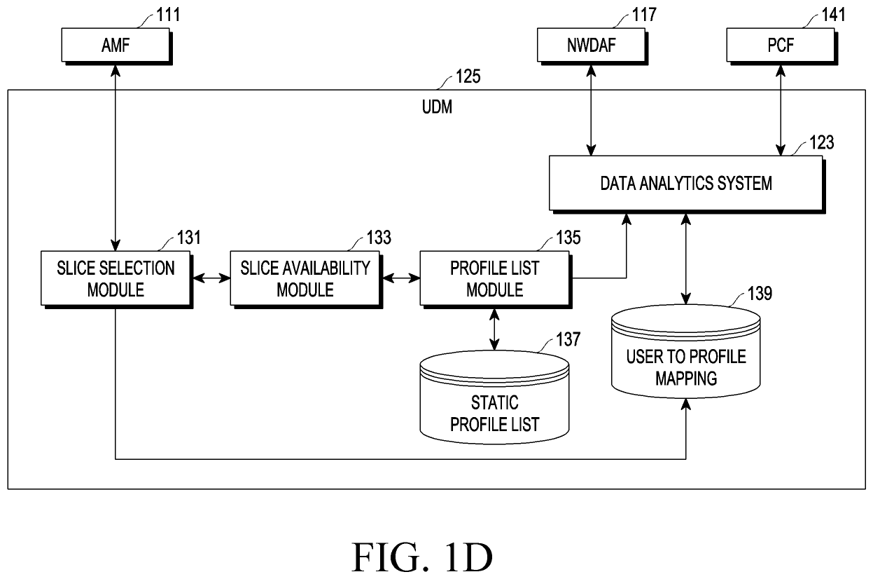

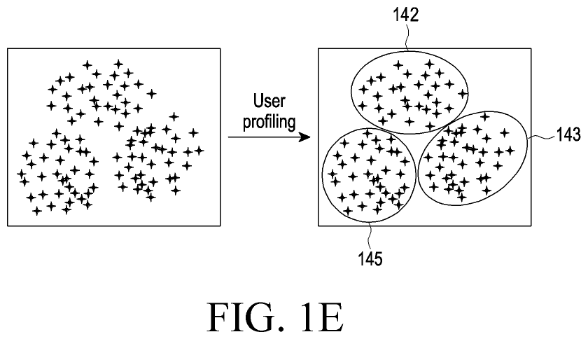

FIG. 1A shows an exemplary architecture for dynamic network slice allocation in a telecommunication network using a data analytics system, in accordance with one or more embodiments.

Exemplary architecture illustrates network components and User Equipment (UE) 101₁ to UE 101_{N} (also collectively referred as one or more UEs 101). The one or more UEs 101 are connected with the network components of a telecommunication network 103. As an example, the telecommunication network 103 may be 5^{th} Generation (5G) network. The network components may include control plane 105 and user plane 107. The control plane 105 and user plane 107 includes a plurality of interconnected Network Functions (NFs) which are defined by the 3GPP for delivering the control plane 105 functionality and user plane 107 functionality of a communication system. The plurality of interconnected NFs may be interconnected NFs with each NF authorized to access the services of other NFs. The NFs in the control plane 105 may include, without limitation, one or more Access and Mobility Function (AMF 111), Network Slice Selection Function (NSSF) 113, Session Management Function (SMF) 115 function and a Network Data Analytics Function (NWDAF) 117. In an embodiment, one or more AMFs 111 may include, without limitation, a default AMF 109, and an allocated AMF 111 (as shown in FIG. 1A and 1B). The default AMF 109 may be allocated to the UE 101_{N} when the UE 101_{N} is powered ON and the allocated AMF 111 may refer to the AMF 111 among the one or more AMFs 111 that is allocated based on application usage pattern of the UE 101_{N}. The NFs in the user plane 107 may include, without limitation, User Plane Function (UPF) 119 and one or more data networks (121₁-121_{N}). In an embodiment, the NSSF 113 may include a data analytics system 123 which may be configured to perform the method according to one or more embodiments. In some embodiments, the data analytics system 123 may be configured in Unified Data Management (UDM) 125 of the control plane 105 (as shown in FIG. 1B). In some embodiments, the data analytics system 123 may be external and associated with the NSSF 113 through a communication network. In some embodiments, the data analytics system 123 may be external and associated with the UDM 125 through the communication network. As an example, the communication network may be a wired communication network, a wireless communication network or a combination of both.

FIG. 1C illustrates an exemplary NSSF 113 which includes the data analytics system 123. In an embodiment, an existing NSSF 113 may include slice selection module 131 and slice availability module 133. The slice selection module 131 and slice availability module 133 perform slice selection based on conventional 3GPP procedure. The profile list module 135 maintains configurable static user profiles which can be allocated to users with default list. During initial registration, UE 101_{N} receives the SNSSAI which is allowed by NSSF in response to the registration request by the UE 101_{N}. The profile list module 135 may store a static profile which stores a default profile which may be allocated to the UE 101_{N} when UE 101_{N} is connected initially. Upon monitoring application usage pattern of the UE 101_{N}, the SNSSAI value may be updated, which is also updated in the profile list module 135. The profile list module 135 may be configured using NSSF 113 Operations Administration and Maintenance (OAM). The slice selection module 131 communicates with the AMF 111 when there is a change in network slice allocated to the UE 101_{N}. The data analytics system 123 communicates with NWDAF 117 to receive UE 101_{N} communication service data and service experience data of the UE 101_{N}. Also, the data analytics system 123 communicates with Policy Control Function (PCF) 141 for efficient rule generation. The functionality of the components illustrated in FIG. 1C will be explained in further part of the description. Although the FIG. 1C shows the components of the NSSF 113, it is to be understood that other embodiments are not limited thereon. In other embodiments, the NSSF 113 may include less or a greater number of components. Further, the labels or names of the components are used only for illustrative purpose and does not limit the scope. One or more components can be combined together to perform same or substantially similar technical feature for the dynamic network slice allocation in a telecommunication network 103.

In an embodiment, when the UE 101_{N} is powered ON, a default network slice is allocated to the UE 101_{N}. As an example, the default network slice may be allocated based on type of the UE 101_{N}. As an example, the UE 101_{N} may include, without limitation, any device used by a user to at least one of communicate and access content such as, but not limited to, mobile phones, smartphones, laptops, wearables, and Internet of Things (IoTs). Each network slice may be identified using a Single Network Slice Selection Assistance Information (S-NSSAI) value. Further, the S-NSSAI value may include, without limitation, Slice/Service Type (SST) and Slice Differentiator (SD). The SST may identify the type of network slice, such as a network slice for mobile broadband, Internet of Things (IoT) and the like. The SD may be a field that may further differentiate network slices of the same type.

In an embodiment, the data analytics system 123 may be configured to monitor an application usage pattern of one or more UEs 101 when the one or more UEs 101 are connected to the default network slice in the telecommunication network 103. The application usage pattern of the one or more UEs 101 may be monitored based on the UE 101_{N} communication service data available at a first network function of the telecommunication network 103. As an example, the first network function may be, without limitation, a Network Data Analytics Function (NWDAF) 117 in 5G network. In an embodiment, the UE 101_{N} communication service data may include, without limitation, an application Identity (ID) of an application used by the UE 101_{N}, a Data Network Name (DNN), uplink traffic volume, downlink traffic volume, interval time of periodic communication of the UE 101_{N} and duration of communication of the UE 101_{N}.

In an embodiment, upon monitoring the application usage pattern, the data analytics system 123 may be configured to classify each of the one or more UEs 101 into a plurality of categories based on the application usage pattern of each of the one or more UEs 101. As an example, the plurality of categories may include, without limitation, audio streaming users, video streaming users, message application using users, browsing application using users and gaming users. As shown in FIG. 1E, each of the one or more UEs 101 into a plurality of categories based on the application usage pattern of each of the one or more UEs 101. Referring to FIG. 1E, the cluster 142 may be video streaming users, the cluster 143 may be message application using users and the cluster 145 may be browsing application using users. As an example, when a user is using the video streaming application on the UE 101_{N} for a predefined duration, the UE 101_{N} will be classified into video streaming application category. After a duration, if the user switches to messaging application, the UE 101_{N} will be classified into messaging application category. In an embodiment, the data analytics system 123 may be configured for classifying the UE 101_{N} into a category in the plurality of categories based on the application usage pattern of the UE 101_{N} continuously and/or at predefined time intervals.

In an embodiment, upon classifying each of the one or more UEs 101, the data analytics system 123 may be configured to allocate a network slice having a predefined QoS (Quality of Service) to each of the one or more UEs 101 categorized in each of the plurality of categories. The network slice allocated to each of the one or more UEs 101 in one category may be different from the network slice allocated to each of the one or more UEs 101 in other categories of the plurality of categories. In an embodiment, the data analytics system 123 may redirect connection of the one or more UEs 101 from the default network slice to the allocated network slice without changing a S-NSSAI value indicative of the default network slice in the one or more UEs 101. In an embodiment, the default configured rules for static profiles is present in the data analytics system 123. The data analytics system 123 communicates the rules associated with the allocated network slice with the PCF 141 for efficient rule generation.

Upon allocating the network slice, the data analytics system 123 may be configured to monitor a Mean Opinion Score (MOS) value of the one or more UEs 101 indicative of service experience of one or more applications being used in each of the one or more UEs 101. In an embodiment, the data analytics may also identify, without limitation, network area of the UE 101_{N} where the service experience is monitored, application ID of the application used in the UE 101_{N} and Data Network Name (DNN) with network identifier and operator identifier. Further, the data analytics system 123 may be configured to update the network slice allocated for the one or more UEs 101 with a new network slice when the MOS value of the one or more UEs 101 in the one of the plurality of categories is below a predefined threshold value. As an example, consider the user is using the video streaming application or a messaging application or a gaming application on the UE 101_{N} simultaneously. The data analytics system 123 may be configured for allocating the network slice having the predefined QoS which may fulfill the QoS requirements for video streaming application, a messaging application and a gaming application, all of them combined. In the above example, when the network slice is updated, the S-NSSAI value in the UE 101_{N} is not changed. In an embodiment, the QoS for the UE 101_{N} is updated as per the application usage pattern and the UE 101_{N} is currently connected with the default network slice. However, the connection from the default AMF 109 with the default network slice is updated to the AMF 111 with the allocated network slice. The connection of the UE 101 is redirected from the default AMF 109 to the AMF 111 with the allocated network slice. The default network slice of the UE 101_{N} remains the same as the S-NSSAI value in the UE 101_{N} is not changed.

In some embodiment, during the mobility of the UE 101_{N}, handover procedure may take place to continuously provide services to the UE 101_{N} without interruptions. To allocate the network slice to the UE 101_{N} when the UE 101_{N} moves to a different location, the data analytics system 123 may determine a movement pattern of the one or more UEs 101 based on one or more previous handovers of the one or more UEs 101 in the telecommunication network 103 using a UE communication service data available at a first network function of the telecommunication network 103. As an example, the first network function may be, without limitation, NWDAF 117 in the 5G network. Consider an exemplary scenario in which the UE 101_{N} moves between location A and location B frequently, the data analytics system 123 may determine a movement pattern of the UE 101_{N} between location A and location B using the information related to the one or more previous handovers. Further, the data analytics system 123 may pre-allocate a corresponding subsequent network slice to be allocated to the one or more UEs 101 based on the movement pattern of the one or more UEs 101 and a corresponding stored list of network slices allocated to the one or more UEs 101 in the one or more previous handovers. Considering the example discussed above, the data analytics system 123 may pre-define the corresponding subsequent network slice to be allocated in the location B when the UE 101_{N} moves from location A to location B without again monitoring the application usage pattern of the UE 101_{N}. However, if the application usage pattern of the UE 101_{N} changes in the location B, the data analytics system 123 may allocate the network slice based on the application usage pattern.

In some embodiments, as shown in FIG. 1D, the data analytics system 123 may be configured in the UDM 125. The components in the UDM 125 may be same as the components in NSSF 113. Although the FIG. 1D shows the components of the UDM 125, it is to be understood that other embodiments are not limited thereon. In other embodiments, the UDM 125 may include less or a greater number of components. Further, the labels or names of the components are used only for illustrative purpose and does not limit the scope. One or more components can be combined together to perform same or substantially similar technical feature for the dynamic network slice allocation in a telecommunication network 103.

In an embodiment, when the data analytics is configured in the UDM 125, the data analytics system 123 may be configured to transmit information related to the corresponding allocated network slice to the corresponding one or more UEs 101 for replacing information related to a default network slice in the one or more UEs 101 with the information related to the corresponding allocated network slice, indicative of a change of the default network slice of the one or more UEs 101 to the corresponding allocated network slice. Upon receiving the information, the UE 101_{N} may be configured to replace information related to a default network slice in the UE 101_{N} with the information related to the allocated network slice in the UE 101_{N}. As an example, to update the information in the UE 101_{N}, the UE 101_{N} may update/change the S-NSSAI information of the default network slice in the UE 101_{N} with the S-NSSAI information of the allocated network slice. After updating, the UE 101_{N} may establish a connection with the allocated network slice upon replacing the information related to the default network slice in the UE 101_{N}. To establish the connection, the UE 101_{N} may transmit a registration request to a second network element that facilitates the allocated network slice. As an example, the second network element may be AMF 111 supporting the allocated network slice. Upon allocating the network slice, the data analytics system 123 may be configured to monitor the MOS value of the one or more UEs 101 indicative of service experience of one or more applications being used in each of the one or more UEs 101. In an embodiment, the data analytics may also identify, without limitation, network area of the UE 101_{N} where the service experience is monitored, application ID of the application used in the UE 101_{N} and DNN with network identifier and operator identifier. Further, the data analytics system 123 may be configured to update the network slice allocated for the one or more UEs 101 with a new network slice when the MOS value of the one or more UEs 101 in the one of the plurality of categories is below a predefined threshold value. As an example, consider the user is using the video streaming application or a messaging application or a gaming application on the UE 101_{N} simultaneously. The data analytics system 123 may be configured for allocating the network slice having the predefined QoS which may fulfill the QoS requirements for video streaming application, a messaging application and a gaming application, all of them combined. The UE 101_{N} may receive information related to the allocated network slice and update the default network slice with the allocated network slice. During establishing the connection with the allocated network slice, the connection of the UE 101_{N} with the telecommunication network 103 may be interrupted. In the above example, when the network slice is updated, the S-NSSAI value in the UE 101_{N} is also updated.

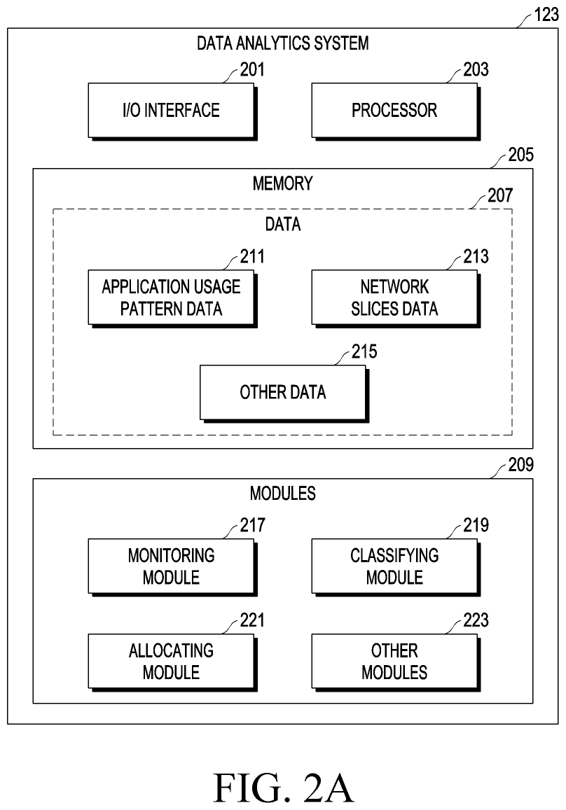

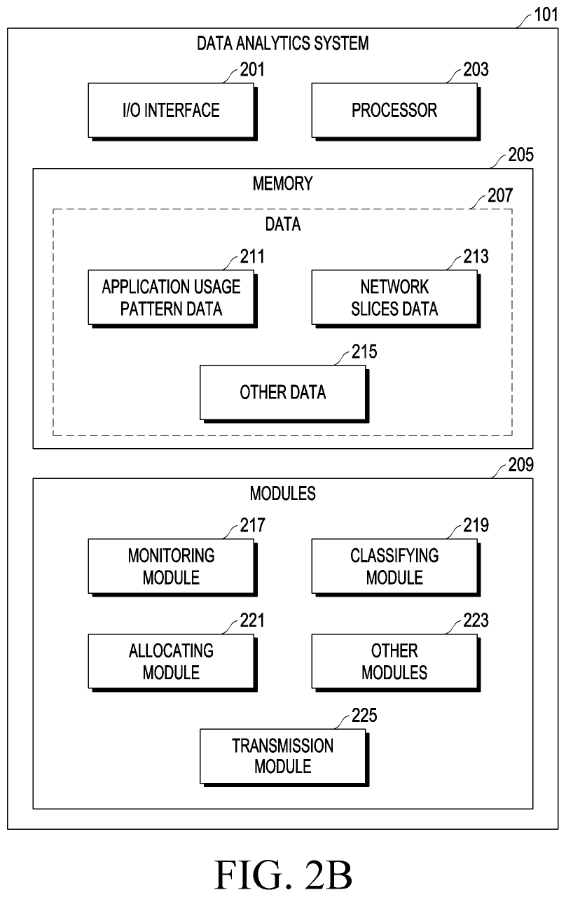

FIG. 2A and FIG. 2B show detailed block diagrams of data analytics system 123, in accordance with one or more embodiments.

In some embodiments, the data analytics system 123 may be implemented in an electronic device. The electronic device may be a part of a network entity (e.g. the NSSF 113 or the UDM125) or may also implement the network entity. The data analytics system 123 may include an I/O interface 201, a processor 203 and a memory 205. In an embodiment, the memory 205 may be communicatively coupled to the processor 203. The processor 203 may be configured to perform one or more functions of the data analytics system 123 for dynamic network slice allocation in a telecommunication network 103, using the data 207 and the one or more modules 209 of the data analytics system 123. In an embodiment, the memory 205 may store data 207.

In an embodiment, the data 207 stored in the memory 205 may include, without limitation, application usage pattern data 211, network slices data 213, and other data 215. In some embodiments, the data 207 may be stored within the memory 205 in the form of various data structures. Additionally, the data 207 may be organized using data models, such as relational or hierarchical data models. The other data 215 may include various temporary data and files generated by the one or more modules 209.

In an embodiment, the application usage pattern data 211 may store application usage pattern of each of one or more User Equipment (UEs) 101 which is monitored based on a UE communication service data available at a first network function of the telecommunication network 103. In an embodiment, the UE communication service data may include, without limitation, an application Identity (ID) of an application used by the UE 101_{N}, a Data Network Name (DNN), uplink traffic volume, downlink traffic volume, interval time of periodic communication of the UE 101_{N} and duration of communication of the UE 101_{N}. The application ID may indicate the application being used in each of the one or more UEs 101. As an example, the application may be, without limitation, video streaming application, web browsing application and gaming application. Each application may be identified using a unique ID. The DNN may be used to identify data networks. The DNN may be used in 5^{th} Generation (5G) network, which may be similar to Access Point Name (APN) in 4^{th} Generation (5G) network. The uplink traffic volume may indicate amount of data transmitted from each of the one or more UEs 101 to the telecommunication network 103. The downlink traffic volume may indicate amount of data transmitted from the telecommunication network 103 to each of the one or more UEs 101. The interval time of periodic communication of the UE 101_{N} may be time duration between two consecutive transmissions between each of the one or more UEs 101 and the telecommunication network 103. The duration of communication of the UE 101_{N} may indicate the total time consumed during the communication of the UE 101_{N}.

In an embodiment, the network slices data 213 may store information related to network slices allocated to each of the one or more UEs 101. In an embodiment, each of the one or more UEs 101 may be connected to a default network slice in the telecommunication network 103. Each of the one or more UEs 101 may be classified into a plurality of categories based on the application usage pattern data 211 of each of the one or more UEs 101. Upon classification, a network slice having a predefined QoS (Quality of Service) may be allocated to each of the one or more UEs 101 categorized in each of the plurality of categories. The network slices data 213 may be updated when the network slice is allocated to the each of the one or more UEs 101. In an embodiment, the network slices data 213 may also store Single Network Slice Selection Assistance Information (S-NSSAI) of each network slice. Further, the S-NSSAI value may include, without limitation, Slice/Service Type (SST) and Slice Differentiator (SD). The SST may identify the type of network slice, such as a network slice for mobile broadband, Internet of Things (IoT) and the like. The SD may be a field that may be used to further differentiate network slices of the same type. In some embodiments, the network slices data 213 which may include information related to the allocated network slice may also be transmitted to the UE 101_{N} for updating the network slice information in the UE 101_{N} with the information related to the allocated network slice.

In an embodiment, the data 207 may be processed by one or more modules 209 of the data analytics system 123. In some embodiments, the one or more modules 209 may be communicatively coupled to the processor 203 for performing one or more functions of the data analytics system 123. In an embodiment, the one or more modules 209 may include, without limiting to, a monitoring module 217, a classifying module 219, an allocating module 221 and other modules 223. In some embodiments, the data analytics system 123 may also include a transmission module 225 (as shown in FIG. 2B).

As used herein, the term module may refer to an Application Specific Integrated Circuit (ASIC), an electronic circuit, a hardware processor 203 (shared, dedicated, or group) and memory that execute one or more software or firmware programs, a combinational logic circuit, and/or other components that provide the described functionality. In an embodiment, each of the one or more modules 209 may be configured as stand-alone hardware computing units. In an embodiment, the other modules 223 may be used to perform various miscellaneous functionalities on the data analytics system 123. It will be appreciated that such one or more modules 209 may be represented as a single module or a combination of different modules.

In an embodiment, the monitoring module 217 may be configured for monitoring an application usage pattern of one or more User Equipment (UEs) 101 when the one or more UEs 101 is connected to a default network slice in the telecommunication network 103. Further, the monitoring module 217 may be configured to monitor the application usage pattern of the one or more UEs 101 based on a UE communication service data available at a first network function of the telecommunication network 103. As an example, the first network function may be, without limitation, a network data analytics function (NWDAF) 117 in 5G network. In an embodiment, the UE communication service data may include, without limitation, an application Identity (ID) of an application used by the UE 101_{N}, a Data Network Name (DNN), uplink traffic volume, downlink traffic volume, interval time of periodic communication of the UE 101_{N} and duration of communication of the UE 101_{N}. In an embodiment, the monitoring module 217 may be configured for monitoring the application usage pattern of one or more UEs 101 in at least one of predefined intervals and continuously.

In an embodiment, the classifying module 219 may be configured for classifying each of the one or more UEs 101 into a plurality of categories based on the application usage pattern of each of the one or more UEs 101. As an example, the plurality of categories may be, without limitation, audio streaming users, video streaming users, message application using users, browsing application using users and gaming users. As an example, when a user is using the video streaming application on the UE 101_{N} for a predefined duration, the UE 101_{N} will be classified into video streaming application category. After a duration, if the user switches to messaging application, the UE 101_{N} will be classified into messaging application category. The classifying module 219 may be configured for continuously classifying the UE 101_{N} into a category in the plurality of categories based on the application usage pattern of the UE 101_{N}.

In an embodiment, the allocating module 221 may be configured for allocating a network slice having a predefined QoS (Quality of Service) to each of the one or more UEs 101 based on the corresponding category of the plurality of categories that each of the one or more UEs 101 are categorized into. The network slice allocated to each of the one or more UEs 101 in one category is different from the network slice allocated to each of the one or more UEs 101 in other categories of the plurality of categories. Upon allocating, the allocating module 221 may be configured for redirecting the connection of the one or more UEs 101 from the default network slice to the corresponding allocated network slice without changing a Single Network Slice Selection Assistance Information (S-NSSAI) value indicative of the default network slice in each of the one or more UEs 101. The S-NSSAI value is not changed in the UE 101_{N} and the connection of the UE 101_{N} with the telecommunication network 103 may not be interrupted. As an example, when the user is using the video streaming application on the UE 101_{N} for a predefined duration, the UE 101_{N} will be classified into video streaming application category. The allocating module 221 may be configured for allocating the network slice having the predefined QoS for the video streaming application. After a duration, if the user switches to messaging application, the UE 101_{N} will be classified into messaging application category and the allocating module 221 may be configured for allocating the network slice having the predefined QoS for the messaging application. In the above example, when the network slice is updated, the S-NSSAI value in the UE 101_{N} is not changed. However, the QoS provided to the UE 101_{N} is updated based on the application usage pattern due to redirection of the connection of the UE 101_{N} to the allocated network slice from the default network slice.

In an embodiment, upon allocating the network slice, the monitoring module 217 may be configured for monitoring a Mean Opinion Score (MOS) value of the one or more UEs 101 indicative of service experience of one or more applications being used in each of the one or more UEs 101. Further, the updating module may be configured for updating the network slice allocated for the one or more UEs 101 with a new network slice when the MOS value of the one or more UEs 101 in the one of the plurality of categories is below a predefined threshold value. Table 1 below shows exemplary value of the service experience in the UE 101_{N} in which three applications are currently used.

TABLE 1

| NWDAF | | |
|---|---|---|
| Data | Details | Value |
| Application ID | Determine application ID | x₁ |
| Bandwidth request | Required Bandwidth | x₂ |
| DNN | Identifies DNN, a full DNN with | x₃ |
| | both the Network Identifier and | |
| | Operator Identifier | |
| Uplink volume | Identifies the uplink traffic volume | x₄ |
| Downlink volume | Identifies the downlink traffic | x₅ |
| | volume | |
| Time period | Identifies interval time of periodic | x₆ |
| | communication | |
| Communication | Identifies the duration of the | x₇ |
| duration | communication | |

The above values may be transmitted as an input to a trained machine learning model which will result into corresponding score (Rn) of the application ID. Rn score serves as weights for applications where higher score represents higher usage of application by user. Final MOS will be calculated as weighted average of observed service MOS of applications.

In an embodiment, the allocating module 221 may also be configured to determine a movement pattern of the one or more UEs 101 based on one or more previous handovers of the one or more UEs 101 in the telecommunication network 103 using a UE communication service data available at a first network function of the telecommunication network 103. Further, the allocating module 221 may also be configured to pre-define a corresponding subsequent network slice to be allocated to the one or more UEs 101 based on the movement pattern of the one or more UEs 101 and a corresponding stored list of network slices allocated to the one or more UEs 101 in the one or more previous handovers.

In one or more embodiments, when the change of network slice includes interference of the UE 101_{N}, the data analytics system 123 may include an additional module such as a transmission module 225 as shown in FIG. 2B. The functionality of the modules such as monitoring module 217, classifying module 219 and allocating module 221 shall remain same as discussed above in the description of FIG. 2A. In an embodiment, the transmission module 225 may be configured to transmit information related to the corresponding allocated network slice to the corresponding one or more UEs 101 for replacing information related to a default network slice in the one or more UEs 101 with the information related to the corresponding allocated network slice, indicative of a change of the default network slice of the one or more UEs 101 to the corresponding allocated network slice. As an example, the transmitting module may transmit the information comprising S-NSSAI value to the UE 101_{N}. Upon receiving the information related to the allocated network slice, the UE 101_{N} may update the information related to the default network slice with the information related to the allocated network slice that causes the UE 101_{N} to establish a connection with allocated network slice thereafter, which provides QoS based on the application usage pattern.

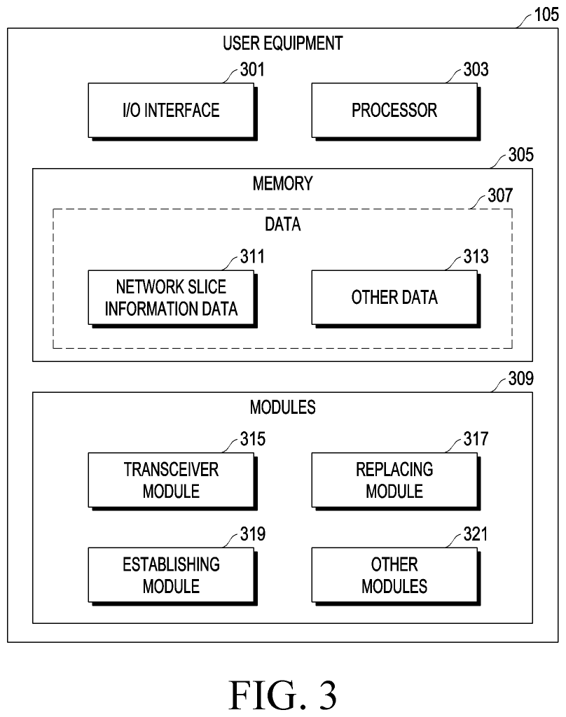

FIG. 3 shows a detailed block diagram of a User Equipment (UE) 101_{N}, in accordance with one or more embodiments.

In some embodiments, the UE 101_{N} may include an I/O interface 301, a processor 303 and a memory 305. In an embodiment, the memory 305 may be communicatively coupled to the processor 303. The processor 303 of the UE 101_{N} may be configured to perform one or more functions of the UE 101_{N} for dynamic network slice allocation in a telecommunication network 103, using the data 307 and the one or more modules 309 of the data analytics system 123 UE 101. In an embodiment, the memory 305 of the UE 101_{N} may store data 307.

In an embodiment, the data 307 stored in the memory 305 may include, without limitation, network slice information data 311 and other data 313. In some embodiments, the data 307 may be stored within the memory 305 of the UE 101_{N} in the form of various data structures. Additionally, the data 307 may be organized using data models, such as relational or hierarchical data models. The other data 313 may include various temporary data and files generated by the one or more modules 309.

In an embodiment, the network slice information data 311 may store information related to network slice allocated to the UE 101_{N}. In an embodiment, the network slice information data 313 may also store Single Network Slice Selection Assistance Information (S-NSSAI) of each network slice. Further, the S-NSSAI value may include, without limitation, Slice/Service Type (SST) and Slice Differentiator (SD). The SST may identify the type of network slice, such as a network slice for mobile broadband, Internet of Things (IoT) and the like. The SD may be a field that may further differentiate network slices of the same type. In an embodiment, when the UE 101_{N} connects with the telecommunication network 103, a default network slice is allocated. The information related to the default network slice may be stored in network slice information data 311. In an embodiment, when a network slice is allocated to the UE 101_{N} based on the application usage pattern, the UE 101_{N} may receive information related to a network slice indicative of the network slice allocated to the UE 101_{N} from a data analytics system 123 associated with the telecommunication network 103. Further, the UE 101_{N} may replace information related to a default network slice in the network slice information data 311 of the UE 101_{N} with the information related to the allocated network slice in the UE 101_{N}.

In an embodiment, the data 307 may be processed by one or more modules 309 of the UE 101. In some embodiments, the one or more modules 309 may be communicatively coupled to the processor 303 of the UE 101_{N} for performing one or more functions of the data analytics system 123. In an embodiment, the one or more modules 309 may include, without limiting to, a transceiver module 315, a replacing module 317, an establishing module 319 and other modules 321.

As used herein, the term module may refer to an Application Specific Integrated Circuit (ASIC), an electronic circuit, a hardware processor 303 (shared, dedicated, or group) and memory that execute one or more software or firmware programs, a combinational logic circuit, and/or other components that provide the described functionality. In an embodiment, each of the one or more modules 309 may be configured as stand-alone hardware computing units. In an embodiment, the other modules 321 may be used to perform various miscellaneous functionalities on the data analytics system 123. It will be appreciated that such one or more modules 309 may be represented as a single module or a combination of different modules.

In an embodiment, the transceiver module 315 may be configured for receiving information related to a network slice indicative of the network slice allocated to the UE 101_{N} from a data analytics system 123 associated with the telecommunication network 103. As an example, the information related to the network slice may include a Single Network Slice Selection Assistance Information (S-NSSAI) value of the network slice. In an embodiment, the network slice may be allocated to the UE 101_{N} based on the application usage pattern of the UE 101_{N} as discussed in detail in the FIGS. 2A and 2B.

In an embodiment, the replacing module 317 may be configured for replacing information related to a default network slice in the UE 101_{N} with the information related to the allocated network slice in the UE 101_{N}. In an embodiment, when the UE 101_{N} connects with the telecommunication network 103, a default network slice is allocated. The information related to the default network slice may be replaced with the information related to the allocated network slice. As an example, the S-NSSAI value associated with the default network slice may be replaced with the S-NSSAI value of the allocated network slice.

In an embodiment, the establishing module 319 may be configured for establishing a connection with the allocated network slice upon replacing the information related to the default network slice in the UE 101_{N}. In an embodiment, when the S-NSSAI value is updated in the UE 101_{N}, the connection of the UE 101_{N} with the telecommunication network 103 may be interrupted, to establish connection with the telecommunication network 103 and resume the services utilized by the UE 101_{N}, the establishing module 319 may be configured for establishing the connection with the allocated network slice. In an embodiment, for establishing the connection, the transceiver module 315 may transmit a registration request to a second network element that facilitates the allocated network slice. As an example, the second network element may be Access and Mobility Function (AMF) 111 which facilitates the allocated network slice.

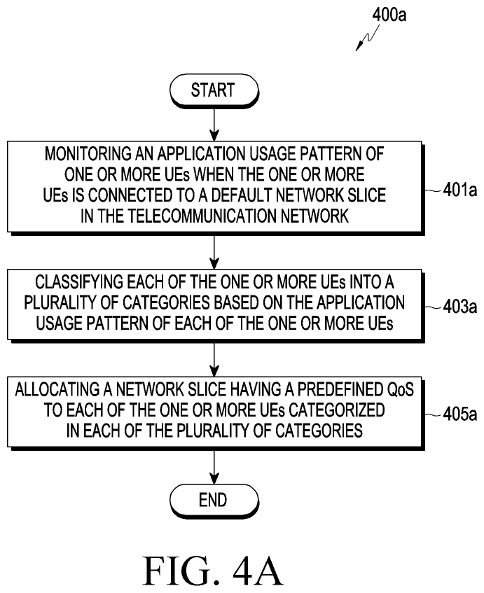

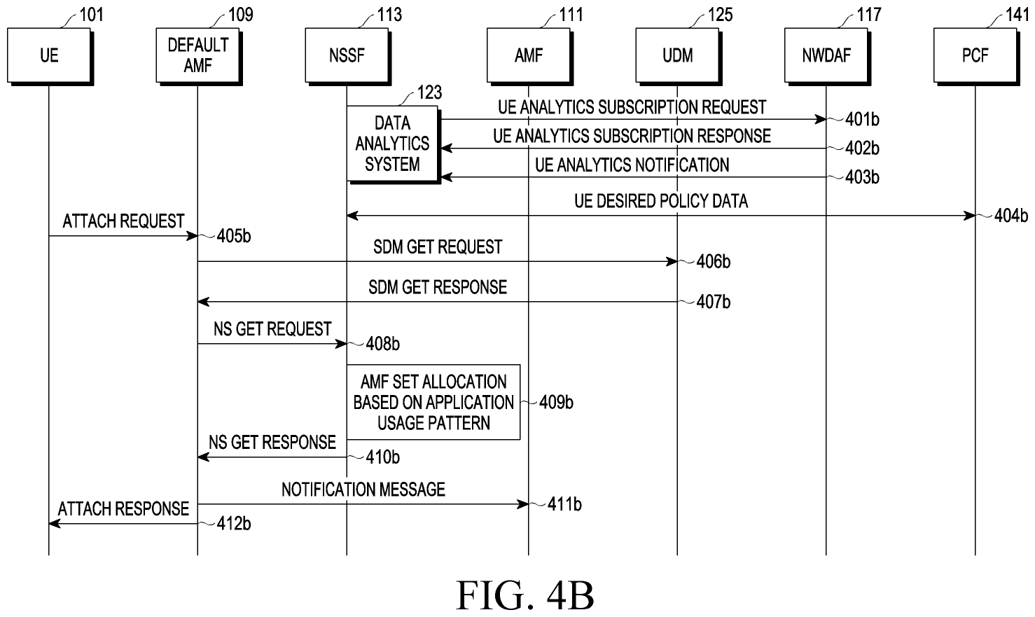

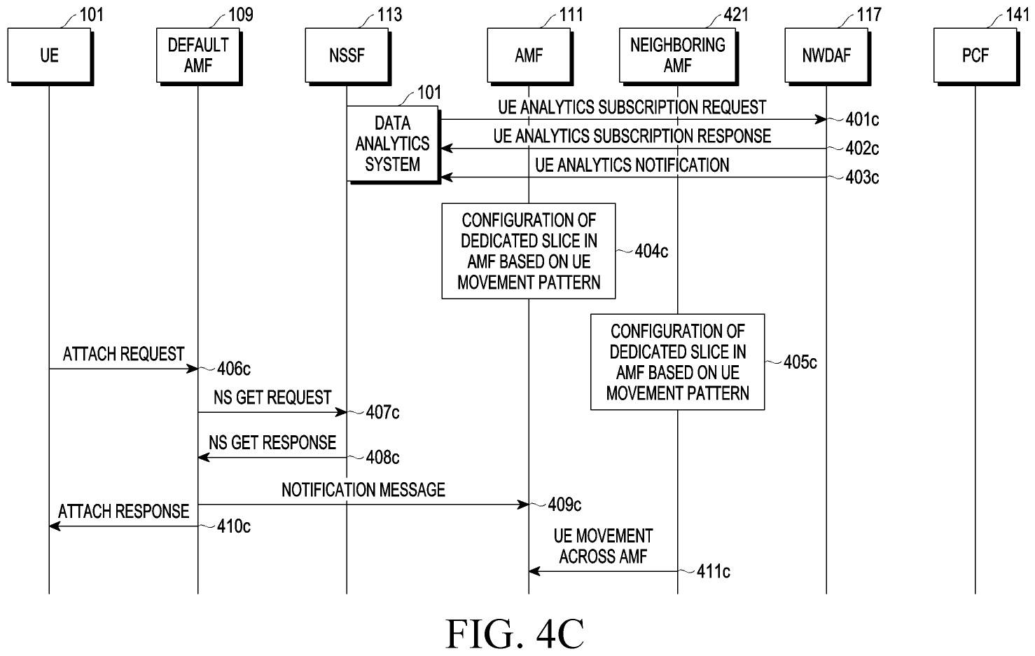

FIG. 4A shows a flowchart illustrating an exemplary method of dynamic network slice allocation in a telecommunication network 103, in accordance with one or more embodiments.

As illustrated in FIG. 4A, the method 400 may include one or more blocks illustrating a method of dynamic network slice allocation in a telecommunication network 103 using the data analytics system 123 illustrated in FIG. 2A. The method 400 may be described in the context of computer executable instructions. Computer executable instructions may include routines, programs, objects, components, data structures, procedures, modules, or functions, which perform functions or implement data types.

The order in which the method 400 is described is not intended to be construed as a limitation, and any number of the described method blocks can be combined in any order to implement the method. Furthermore, the method may be implemented in a variety of hardware, software, firmware, or combination thereof.

At block 401, the method 400 includes monitoring, by a processor 203 of the data analytics system 123, an application usage pattern of one or more User Equipment (UEs) 101 when the one or more UEs 101 is connected to a default network slice in the telecommunication network 103. The application usage pattern of the one or more UEs 101 is monitored based on a UE communication service data available at a first network function of the telecommunication network 103.

At block 403, the method 400 includes classifying, by the processor 203, each of the one or more UEs 101 into a plurality of categories based on the application usage pattern of each of the one or more UEs 101.

At block 405, the method 400 includes allocating, by the processor 203, a network slice having a predefined Quality of Service (QoS) to each of the one or more UEs 101 categorized in each of the plurality of categories. The network slice allocated to each of the one or more UEs 101 in one category is different from the network slice allocated to each of the one or more UEs 101 in other categories of the plurality of categories. The processor may redirect connection of the one or more UEs 101 from the default network slice to the allocated network slice without changing a Single Network Slice Selection Assistance Information (S-NSSAI) value indicative of the default network slice in the one or more UEs 101. Upon allocating the network slice, the processor 203 may monitor a Mean Opinion Score (MOS) value of the one or more UEs 101 indicative of service experience of one or more applications being used in each of the one or more UEs 101 upon allocating the network slice having the predefined QoS. Further, the processor 203 may update the network slice allocated for the one or more UEs 101 with a new network slice when the MOS value of the one or more UEs 101 in the one of the plurality of categories is below a predefined threshold value. Additionally, the processor 203 may determine a movement pattern of the one or more UEs 101 based on one or more previous handovers of the one or more UEs 101 in the telecommunication network 103 using a UE communication service data available at a first network function of the telecommunication network 103. Upon determining the movement pattern, the processor 203 may pre-define a corresponding subsequent network slice to be allocated to the one or more UEs 101 based on the movement pattern of the one or more UEs 101 and a corresponding stored list of network slices allocated to the one or more UEs 101 in the one or more previous handovers.

FIG. 4B shows an exemplary call flow diagram for dynamic network slice allocation in a telecommunication network 103, in accordance with one or more embodiments.

In an embodiment, the data analytics system 123 may be configured in Network Slice Selection Function (NSSF) 113. When a User Equipment (UE) 101 is powered ON, a default network slice is allocated to the UE 101_{N}. As an example, the default network slice may be allocated based on type of the UE 101_{N}. As an example, the UE 101_{N} may include, without limitation, any device used by a user to at least one of communicate and access content such as, but not limited to, mobile phones, smartphones, laptops, wearables, and Internet of Things (IoTs). At operation 1, the data analytics system 123 may transmit UE analytics subscription request to Network Data Analytics Function (NWDAF) 117. At operation 2, the data analytics system 123 receives UE analytics subscription response. At operation 3, the data analytics system 123 receives UE analytics notification which may comprise an application usage pattern. The data analytics system 123 may monitor an application usage pattern of the UE 101_{N} when the one or more UEs 101 is connected to the default network slice in the telecommunication network 103. The application usage pattern of the one or more UEs 101UE 101 may be monitored based on the UE communication service data available at NWDAF 117. At operation 4, there is an occurrence of NSSF 113 interaction which may be used to decide the policies for the UE 101_{N}. At operation 5, the UE 101_{N} transmits an attach request. During attach request processing when Subscriber Data Management (SDM) GET is sent to Unified Data Management (UDM) 125, the UDM 125 function allocates the default slice information (operations 6 and 7). At operation 8, default AMF 109 which facilitates the default network slice forwards the Network Slice (NS) selection GET request to NSSF 113, the NSSF 113 allocates an AMF 111 set which facilitates a network slice allocated based on the application usage pattern of the UE 101_{N}, which may be assigned for the UE 101_{N} for slice allocation (operation 8, 9 and 10). Finally, the default AMF 109 notifies the allocated AMF 111 and the connection of the UE 101_{N} is redirected to the AMF 111 with the allocated network slice without changing the S-NSSAI value in the UE 101_{N} (operation 11 and 12). The connection of the UE 101_{N} was not interrupted as the allocation of the network slice was performed without the involvement of the UE 101_{N} by redirecting the connection of the UE 101_{N} from the default AMF 109 to the AMF 111 with the allocated network slice. The UE 101_{N} is unaware of the changes in the network slice and the allocation is internally managed within the network functions of the telecommunication network 103.

FIG. 4C shows an exemplary call flow diagram for dynamic network slice allocation in a telecommunication network 103 during handover of a User Equipment (UE) 101, in accordance with one or more embodiments.

In an embodiment, the data analytics system 123 may be configured in Network Slice Selection Function (NSSF) 113. When a User Equipment (UE) 101 is powered ON, a default network slice is allocated to the UE 101_{N}. As an example, the default network slice may be allocated based on type of the UE 101_{N}. At operation 1, the data analytics system 123 may transmit UE analytics subscription request to Network Data Analytics Function (NWDAF) 117. At operation 2, the data analytics system 123 receives UE analytics subscription response. At operation 3, the data analytics system 123 receives UE analytics notification which may comprise an application usage pattern. The data analytics system 123 may monitor an application usage pattern of one or more UEs 101 when the one or more UEs 101 is connected to the default network slice in the telecommunication network 103. The application usage pattern of the one or more UEs 101 may be monitored based on the UE communication service data available at NWDAF 117. At operation 4, using the UE communication service data, the data analytics system 123 determines regular movement pattern of the UE 101_{N} across AMF 111 and configures a network slice in neighboring AMF 421 based on the one or more previous handovers of the UE 101_{N}. Similarly, the data analytics system 123 may configure the network slice in neighboring AMF 421. At operation 6, the UE 101_{N} transmits an attach request. During attach request processing when Subscriber Data Management (SDM) GET is sent to Unified Data Management (UDM) 125, the UDM 125 function allocates the default slice information (operations 7 and 8). Default AMF 111 which facilitates the default network slice forwards the Network Slice (NS) selection GET request to NSSF 113, the NSSF 113 allocates an AMF 111 set which facilitates a network slice allocated based on the application usage pattern of the UE 101_{N}, which may be assigned for the UE 101_{N} for slice allocation. Operation 9, the default AMF 109 notifies the allocated AMF 111 and the connection of the UE 101_{N} is redirected to the AMF 111 with the allocated network slice without changing the S-NSSAI value in the UE 101_{N}. During the UE 101_{N} movement across AMF 111, the allocated network slice may be directly allocated to UE 101 upon detecting handover of the UE 101_{N} to the neighbouring AMF 421 which has already configured the allocated network slice (operation 11). If the allocated slice is not available in the neighbouring AMF 421, the default network slice may be allocated to the UE 101_{N}. The connection of the UE 101_{N} was not interrupted as the allocation of the network slice was performed without the involvement of the UE 101_{N}. The UE 101_{N} is unaware of the changes in the network slice and the allocation is internally managed within the network functions of the telecommunication network 103.

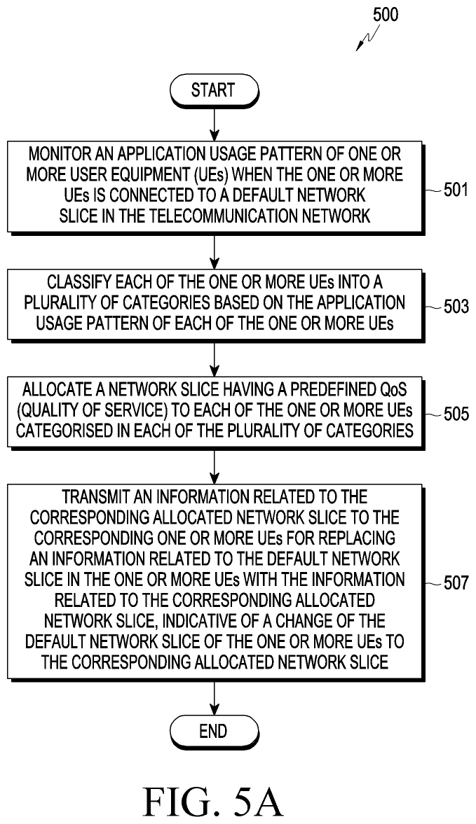

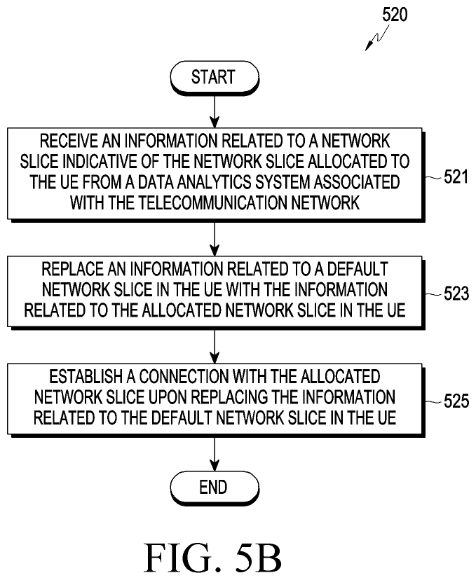

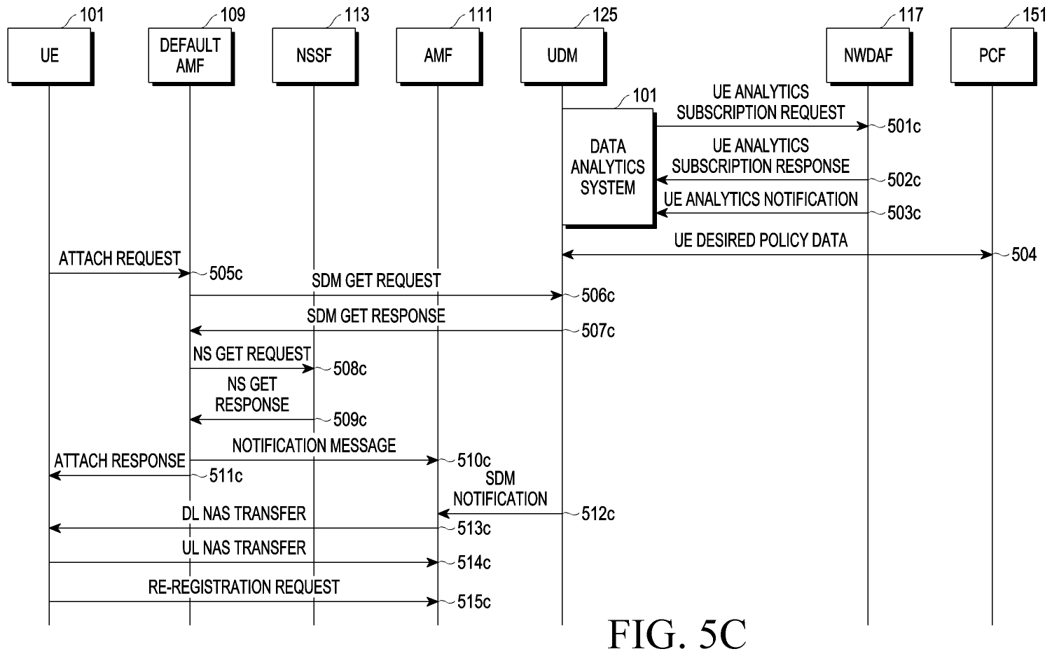

FIG. 5A shows a flowchart illustrating an exemplary method of dynamic network slice allocation in a telecommunication network 103 involving a User Equipment (UE) 101, in accordance with one or more embodiments.

As illustrated in FIG. 5A, the method 500 may include one or more blocks illustrating a method of dynamic network slice allocation with User Equipment involvement (UE) 101 in a telecommunication network 103 using the data analytics system 123 illustrated in FIG. 2B. The method 500 may be described in the context of computer executable instructions. Computer executable instructions may include routines, programs, objects, components, data structures, procedures, modules, or functions, which perform functions or implement data types.

The order in which the method 500 is described is not intended to be construed as a limitation, and any number of the described method blocks can be combined in any order to implement the method. Furthermore, the method may be implemented in a variety of hardware, software, firmware, or combination thereof.

At block 501, the method 500 includes monitoring, by a processor 203 of the data analytics system 123, an application usage pattern of one or more User Equipment (UEs) 101 when the one or more UEs 101 are connected to a default network slice in the telecommunication network 103. The application usage pattern of the one or more UEs 101 is monitored based on a UE communication service data available at a first network function of the telecommunication network 103.

At block 503, the method 500 includes classifying, by the processor 203, each of the one or more UEs 101 into a plurality of categories based on the application usage pattern of each of the one or more UEs 101.

At block 505, the method 500 includes allocating, by the processor 203, a network slice having a predefined Quality of Service (QoS) to each of the one or more UEs 101 categorized in each of the plurality of categories. The network slice allocated to each of the one or more UEs 101 in one category is different from the network slice allocated to each of the one or more UEs 101 in other categories of the plurality of categories.

At block 507, the method 500 includes transmitting, by the processor 203, information related to the corresponding allocated network slice to the corresponding one or more UEs 101 for replacing information related to a default network slice in the one or more UEs 101 with the information related to the corresponding allocated network slice, indicative of a change of the default network slice of the one or more UEs 101 to the corresponding allocated network slice. Upon transmitting the information related to the corresponding allocated network slice, the processor 203 may monitor a Mean Opinion Score (MOS) value of the one or more UEs 101 indicative of service experience of one or more applications being used in each of the one or more UEs 101 upon allocating the network slice having the predefined QoS. Further, the processor 203 may update the network slice allocated for the one or more UEs 101 with a new network slice when the MOS value of the one or more UEs 101 in the one of the plurality of categories is below a predefined threshold value.

FIG. 5B shows a flowchart illustrating an exemplary method performed at User Equipment (UE) 101 for dynamic network slice allocation in a telecommunication network 103, in accordance with one or more embodiments.

As illustrated in FIG. 5B, the method 520 may include one or more blocks illustrating a method performed at User Equipment (UE) 101 for dynamic network slice allocation in a telecommunication network 103 using the data analytics system 123 illustrated in FIG. 3. The method 500 may be described in the context of computer executable instructions. Computer executable instructions may include routines, programs, objects, components, data structures, procedures, modules, or functions, which perform functions or implement data types.

The order in which the method 520 is described is not intended to be construed as a limitation, and any number of the described method blocks can be combined in any order to implement the method. Furthermore, the method may be implemented in a variety of hardware, software, firmware, or combination thereof.

At block 521, the method 520 includes receiving, by a processor 303 of the UE 101_{N}, information related to a network slice indicative of the network slice allocated to the UE 101_{N} from a data analytics system 123 associated with the telecommunication network 103.

At block 523, the method 520 includes replacing, by the processor 303, information related to a default network slice in the UE 101_{N} with the information related to the allocated network slice in the UE 101_{N}.

At block 525, the method 520 includes establishing, by the processor 303, a connection with the allocated network slice upon replacing the information related to the default network slice in the UE 101_{N}. The processor 303 is further configured to transmit a registration request to a second network element that facilitates the allocated network slice.

FIG. 5C shows an exemplary call flow diagram for dynamic network slice allocation in a telecommunication network 103 involving a User Equipment (UE) 101, in accordance with one or more embodiments.

In an embodiment, the data analytics system 123 may be configured in Unified Data Management (UDM) 125. When a User Equipment (UE) 101_{N} is powered ON, a default network slice is allocated to the UE 101_{N}. As an example, the default network slice may be allocated based on type of the UE 101_{N}. At operation 1, the data analytics system 123 may transmit UE analytics subscription request to Network Data Analytics Function (NWDAF) 117. At operation 2, the data analytics system 123 receives UE analytics subscription response. At operation 3, the data analytics system 123 receives UE analytics notification which may comprise an application usage pattern. The data analytics system 123 may monitor an application usage pattern of one or more UEs 101 when the one or more UEs 101 is connected to the default network slice in the telecommunication network 103. The application usage pattern of the one or more UEs 101 may be monitored based on the UE communication service data available at NWDAF 117. At operation 4, the UDM 125 interacts with the PCF 141 to decide the policies for the UE 101_{N}. At operation 5, the UE 101_{N} transmits an attach request. During attach request processing when Subscriber Data Management (SDM) GET is sent to the UDM 125 function, the UDM 125 function allocates the default slice information (operations 6 and 7). At operation 8, default AMF 109 which facilitates the default network slice forwards the Network Slice (NS) selection GET request to NSSF 113, the NSSF 113 allocates an AMF 111 set which facilitates a network slice allocated based on the application usage pattern of the UE 101_{N}, which may be assigned for the UE 101_{N} for slice allocation (operation 8 and 9). At operation 10, the default AMF 109 notifies the allocated AMF 111, and the UE 101_{N} will be attached with the allocated AMF 111. At operation 12, the UDM 125 transmits the SDM notification to the allocated AMF 111. At operation 13, the allocated AMF 111 may perform downlink Non-Access Stratum (NAS) transfer. In response to DL NAS transfer, the UE 101_{N} performs uplink DAS transfer (operation 14). The connection of the UE 101_{N} is interrupted, and the UE 101_{N} transmits a re-registration request to establish connection with the allocated AMF 111 (operation 15).

### Computer System

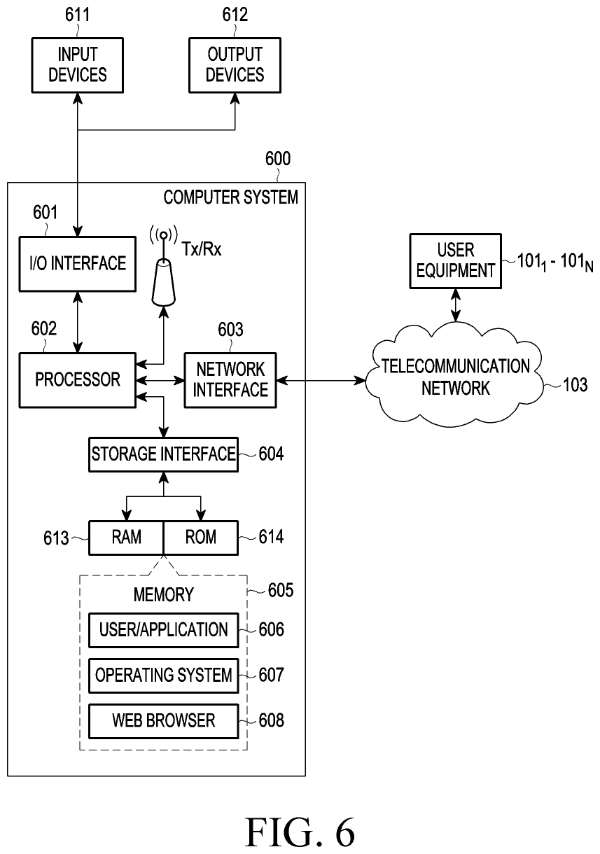

FIG. 6 illustrates a block diagram of an exemplary computer system 600 for implementing one or more embodiments. In an embodiment, the computer system 600 may be the data analytics system illustrated in FIG. 2A and 2B. The computer system 600 may include a central processing unit (“CPU” or “processor” or “memory controller”) 602. The processor 602 may comprise at least one data processor for executing program components for executing user-or system-generated business processes. A user may include a network manager, an application developer, a programmer, an organization, or any system/sub-system being operated parallelly to the computer system 600. The processor 602 may include processing units such as integrated system (bus) controllers, memory controllers/memory management control units, floating point units, graphics processing units, or digital signal processing units, for example.

The processor 602 may be disposed in communication with one or more Input/Output (I/O) devices (611 and 612) via I/O interface 601. The I/O interface 601 may employ communication protocols/methods such as, without limitation, audio, analog, digital, stereo, IEEE®-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE® 802.n/b/g/n/x, Bluetooth, or cellular (for example, Code-Division Multiple Access (CDMA), High-Speed Packet Access (HSPA+), Global System For Mobile Communications (GSM), Long-Term Evolution (LTE) or the like), for example. Using the I/O interface 601, the computer system 600 may communicate with one or more I/O devices 611 and 612.

In some embodiments, the processor 602 may be disposed in communication with a network 609 via a network interface 603. The network interface 603 may communicate with the network 609. The network interface 603 may employ connection protocols including, without limitation, direct connect, Ethernet (for example, twisted pair 10/100/1000 Base T), Transmission Control Protocol/Internet Protocol (TCP/IP), token ring, or IEEE® 802.11a/b/g/n/x, for example.

In an embodiment, the network 609 may be implemented as one of the several types of networks, such as intranet or Local Area Network (LAN) and such within the organization. The network 609 may either be a dedicated network or a shared network, which represents an association of several types of networks that use a variety of protocols, for example, Hypertext Transfer Protocol (HTTP), Transmission Control Protocol/Internet Protocol (TCP/IP), or Wireless Application Protocol (WAP) for example, to communicate with each other. Further, the network 609 may include a variety of network devices, including routers, bridges, servers, computing devices, or storage devices, for example. Using the network interface 603 and the network 609, the computer system 600 may communicate with one or more User Equipment (UEs).

In some embodiments, the processor 602 may be disposed in communication with a memory 605 (for example, RAM 613, or ROM 614, as shown in FIG. 6) via a storage interface 604. The storage interface 604 may connect to memory 605 including, without limitation, memory drives, or removable disc drives, for example, employing connection protocols such as Serial Advanced Technology Attachment (SATA), Integrated Drive Electronics (IDE), IEEE-1394, Universal Serial Bus (USB), fiber channel, or Small Computer Systems Interface (SCSI), for example. The memory drives may further include a drum, magnetic disc drive, magneto-optical drive, optical drive, Redundant Array of Independent Discs (RAID), solid-state memory devices, or solid-state drives, for example.

The memory 605 may store a collection of program or database components, including, without limitation, user/application interface 606, an operating system 607, a web browser 608, and the like. In some embodiments, computer system 600 may store user/application data 606, such as the data, variables, or records, for example. Such databases may be implemented as fault-tolerant, relational, scalable, secure databases such as Oracle® or Sybase®.

The operating system 607 may facilitate resource management and operation of the computer system 600. Examples of operating systems include, without limitation, APPLE® MACINTOSH® OS X®, UNIX®, UNIX-like system distributions (for example., BERKELEY SOFTWARE DISTRIBUTION® (BSD), FREEBSD®, NETBSD®, or OPENBSD), LINUX® DISTRIBUTIONS (for example, RED HAT®, UBUNTU®, or KUBUNTU®), IBM® OS/2®, MICROSOFT® WINDOWS® (XP®, VISTA®/7/8, or 10, for example), APPLE® IOS®, GOOGLE™ ANDROID™, BLACKBERRY® OS, or the like.

The user interface 606 may facilitate display, execution, interaction, manipulation, or operation of program components through textual or graphical facilities. For example, the user interface 606 may provide computer interaction interface elements on a display system operatively connected to the computer system 600, such as cursors, icons, check boxes, menus, scrollers, windows, widgets, and the like. Further, Graphical User Interfaces (GUIs) may be employed, including, without limitation, APPLE® MACINTOSH® operating systems' Aqua®, IBM® OS/2®, MICROSOFT® WINDOWS® (for example, Aero, or Metro), web interface libraries (for example, ActiveX®, JAVA®, JAVASCRIPT®, AJAX, HTML, or ADOBE® FLASH®), or the like.

The web browser 608 may be a hypertext viewing application. Secure web browsing may be provided using Secure Hypertext Transport Protocol (HTTPS), Secure Sockets Layer (SSL), Transport Layer Security (TLS), and the like. The web browsers 608 may utilize facilities such as AJAX, DHTML, ADOBE® FLASH®, JAVASCRIPT®, JAVA®, Application Programming Interfaces (APIs), and the like. Further, the computer system 600 may implement a mail server stored program component. The mail server may utilize facilities such as ASP, ACTIVEX®, ANSI® C++/C #, MICROSOFT®, .NET, CGI SCRIPTS, JAVA®, JAVASCRIPT®, PERL®, PHP, PYTHON®, or WEBOBJECTS®, for example. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 600 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, and the like.

Furthermore, one or more computer-readable storage media may be utilized in implementing one or more embodiments. A computer-readable storage medium refers to any type of physical memory on which information or data readable by a processor may be stored. Thus, a computer-readable storage medium may store instructions for execution by one or more processors, including instructions for causing the processor(s) to perform steps, operations, or stages consistent with the embodiments described herein. The term “computer-readable medium” should be understood to include tangible items and exclude carrier waves and transient signals, for example, non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of one or more embodiments are apparent from the descriptions provided herein.

One or more embodiments dynamically allocates network slice based on the application usage pattern of the UE. This may enhance the user experience and may increase QoS to the UE as the allocated slice fulfills the network requirements of the UE. One or more embodiments may be performed at network end, this helps in updating the network slice of the UE without interrupting the connection of the UE with the network.

One or more embodiments may classify each of the one or more UEs into a plurality of categories based on the application usage pattern. Each category have different QoS. This helps in classifying the user in the correct category which fulfills the network requirement. One or more embodiments may monitor the user experience upon allocating the network slice and updates the network slice if there is a change in user experience. This helps in dynamically updating the network slice which enhances the user experience and the QoS.

One or more embodiments may determine a movement pattern of the UE based on one or more previous handovers of the UE. Using the movement pattern, the network slice to be allocated is pre-defined for the UE during handover of the UE. As the movement pattern of the UE is determined, the network slice to be allocated is predefined in the new location of the UE which helps in dynamically allocating the network slice without monitoring the application usage pattern again in the new location of the UE. The new location here refers to different location from the present location of the UE. This in turn eliminates additional processing for monitoring the application usage pattern and reduces time taken to dynamically allocating a network slice to the UE.

As stated above, it shall be noted that one or more embodiments may be used to address various technical problems related to network slice allocation in a telecommunication network. One or more embodiments have a practical application and may provide a solution to the technical problems associated with the existing approach into network slice allocation in the telecommunication network.

The disclosed operations, according to one or more embodiments, are not routine, conventional, or well-known aspects in the art, and the operations may provide solutions to existing technical problems, and the operations may provide an improvement in the functioning of the system itself.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all the items are mutually exclusive, unless expressly specified otherwise. The terms “a”, “an” and “the” mean “one or more”, unless expressly specified otherwise.

A description of one or more embodiments with several components in communication with each other does not imply that all embodiments include such components. On the contrary, a variety of components are described to illustrate one or more embodiments.

When a single device or article is described herein, it will be clear that more than one device/article (whether they cooperate) may be used in place of a single device/article. Similarly, where more than one device/article is described herein (whether they cooperate), it will be clear that a single device/article may be used in place of the more than one device/article or a different number of devices/articles may be used instead of the shown number of devices or programs. The functionality and/or features of a device may be included in one or more additional devices.

Finally, the language used in herein has been selected for readability and instructional purposes, and is not intended to limit the disclosure thereto. Accordingly, the embodiments described herein are intended to be illustrative of, but not limiting to, the scope of the disclosure.

While various aspects and embodiments have been disclosed herein, other aspects and embodiments may be apparent to those skilled in the art. The various aspects and embodiments disclosed herein are for purposes of illustration and are not intended to be limiting.

Referral Numerals:

| Reference Number | Description |
|---|---|
| 1011-101N | One or more User Equipment (UEs) |
| 103 | Telecommunication network |
| 105 | Control plane |
| 107 | User plane |
| 109 | Default Access and Mobility Function (AMF) |
| 111 | Access and Mobility Function (AMF) |
| 113 | Network Slice Selection Function (NSSF) |
| 115 | Session Management Function (SMF) |
| 117 | Network Data Analytics Function (NWDAF) |
| 119 | User Plane Function (UPF) |
| 121₁-121_{N} | One or more data networks |
| 123 | Data analytics system |
| 125 | Unified Data Management (UDM) |
| 131 | Slice selection module |
| 133 | Slice availability module |
| 135 | Profile list module |
| 137 | Static profile list |
| 139 | User to profile mapping |
| 141 | Policy Control Function (PCF) |
| 201 | I/O Interface |
| 203 | Processor |
| 205 | Memory |
| 207 | Data |
| 209 | Modules |
| 211 | Application usage pattern data |
| 213 | Network slices data |
| 215 | Other data |
| 217 | Monitoring module |
| 219 | Classifying module |
| 221 | Allocating module |
| 223 | Other modules |
| 225 | Transmission module |
| 301 | I/O Interface of the UE |
| 303 | Processor of the UE |
| 305 | Memory of the UE |
| 307 | Data of the UE |
| 309 | Modules of the UE |
| 311 | Network slice information data |
| 313 | Other data |
| 315 | Transceiver module |
| 317 | Determining module |
| 319 | Establishing module |
| 321 | Other modules |
| 421 | Neighboring AMF |
| 600 | Computer system |
| 601 | I/O Interface of the exemplary computer system |
| 602 | Processor of the exemplary computer system |
| 603 | Network interface |
| 604 | Storage interface |
| 605 | Memory of the exemplary computer system |
| 606 | User/Application |
| 607 | Operating system |
| 608 | Web browser |
| 611 | Input devices |
| 612 | Output devices |
| 613 | RAM |
| 614 | ROM |

What is claimed is:

1. A method for network slice allocation by an electronic device for a data analytics system in a telecommunication network, comprising:
monitoring, one or more application usage patterns of one or more user equipment (UEs) which are connected to a default network slice in the telecommunication network;
classifying the one or more UEs into one or more categories based on the one or more application usage patterns; and
allocating, by the data analytics system, one or more network slices having predefined qualities of service (QoS) to the one or more UEs based on the one or more categories.

2. The method of claim 1, wherein the one or more application usage patterns are monitored based on UE communication service data received from a first network function of the telecommunication network.

3. The method of claim 1, wherein a first network slice allocated to one or more first UEs classified according to a first category is different from other network slices allocated to other UEs classified according to other categories.

4. The method of claim 3, further comprising:
monitoring a mean opinion score (MOS) value indicating a service experience of one or more applications being used by the one or more first UEs based on allocating the first network slice; and
replacing the first network slice with a second network slice based on the MOS value being below a predefined threshold value.

5. The method of claim 3, further comprising:
redirecting connection of the one or more first UEs from the default network slice to the first network slice without changing a single network slice selection assistance information (S-NSSAI) value in the one or more first UEs,
wherein the S-NSSAI value indicates the default network slice.

6. The method of claim 3, further comprising:
transmitting first information indicating the first network slice to the one or more first UEs, wherein the first information is for replacing second information indicating the default network slice in the one or more first UEs,
wherein the first information indicates a change of the default network slice of the one or more first UEs to the first network slice.

7. The method of claim 1, further comprising:
determining a movement pattern of the one or more first UEs based on one or more previous handovers in the telecommunication network of the one or more first UEs, wherein the one or more previous handovers are determined based on UE communication service data received from a first network function of the telecommunication network; and
pre-defining a second network slice to be allocated to the one or more first UEs based on the movement pattern and a stored list of one or more second network slices allocated to the one or more first UEs in the one or more previous handovers.

8. An electronic device for a data analytics system for network slice allocation in a telecommunication network, comprising:
one or more processors; and
memory storing instructions, which, when executed by the one or more processors, cause the electronic device to:
monitor one or more application usage patterns of one or more user equipment (UEs) which are connected to a default network slice in the telecommunication network;
classify the one or more UEs into one or more categories based on the one or more application usage patterns; and
allocate one or more network slices having predefined qualities of service (QoS) to the one or more UEs based on the one or more categories.

9. The electronic device of claim 8, wherein the instructions, when executed by the one or more processors, cause the electronic device to monitor the one or more application usage patterns based on UE communication service data received from a first network function of the telecommunication network.

10. The electronic device of claim 8, wherein a first network slice allocated to one or more first UEs classified according to a first category is different from other network slices allocated to other UEs classified according to other categories.

11. The electronic device of claim 10, wherein the instructions, when executed by the one or more processors, cause the electronic device further to:
monitor a mean opinion score (MOS) value indicating a service experience of one or more applications being used by the one or more first UEs based on allocating the first network slice; and
replace the first network slice with a second network slice based on the MOS value being below a predefined threshold value.

12. The electronic device of claim 10, wherein the instructions, when executed by the one or more processors, cause the electronic device further to:
redirect connection of the one or more first UEs from the default network slice to the first network slice without changing a single network slice selection assistance information (S-NSSAI) value in the one or more first UEs,
wherein the S-NSSAI value indicates the default network slice.

13. The electronic device of claim 10, wherein the instructions, when executed by the one or more processors, cause the electronic device to:
transmit first information indicating the first network slice to the one or more first UEs, wherein the first information is for replacing second information indicating the default network slice in the one or more first UEs,
wherein the first information indicates a change of the default network slice of the one or more first UEs to the first network slice.

14. The electronic device of claim 8, wherein the instructions, when executed by the one or more processors, cause the electronic device further to:
determine a movement pattern of the one or more first UEs based on one or more previous handovers in the telecommunication network of the one or more first UEs, wherein the one or more previous handovers are determined based on UE communication service data received from a first network function of the telecommunication network; and
pre-define a second network slice to be allocated to the one or more first UEs based on the movement pattern and a stored list of one or more second network slices allocated to the one or more first UEs in the one or more previous handovers.

15. A non-transitory computer readable storage medium storing instructions which, when executed by one or more processors of an electronic device, cause the electronic device to perform operations, the operations comprising:
monitoring, one or more application usage patterns of one or more user equipment (UEs) which are connected to a default network slice in the telecommunication network;
classifying the one or more UEs into one or more categories based on the one or more application usage patterns; and
allocating, by the data analytics system, one or more network slices having predefined qualities of service (QoS) to the one or more UEs based on the one or more categories.

16. The non-transitory computer readable storage medium of claim 15, wherein the one or more application usage patterns are monitored based on UE communication service data received from a first network function of the telecommunication network.

17. The non-transitory computer readable storage medium of claim 15, wherein a first network slice allocated to one or more first UEs classified according to a first category is different from other network slices allocated to other UEs classified according to other categories.

18. The non-transitory computer readable storage medium of claim 17, wherein the operations further comprises:
monitoring a mean opinion score (MOS) value indicating a service experience of one or more applications being used by the one or more first UEs based on allocating the first network slice; and
replacing the first network slice with a second network slice based on the MOS value being below a predefined threshold value.

19. The non-transitory computer readable storage medium of claim 17, wherein the operations further comprises:
redirecting connection of the one or more first UEs from the default network slice to the first network slice without changing a single network slice selection assistance information (S-NSSAI) value in the one or more first UEs,
wherein the S-NSSAI value indicates the default network slice.

20. The non-transitory computer readable storage medium of claim 17, wherein the operations further comprises:
transmitting first information indicating the first network slice to the one or more first UEs, wherein the first information is for replacing second information indicating the default network slice in the one or more first UEs,
wherein the first information indicates a change of the default network slice of the one or more first UEs to the first network slice.
